(19) United States
(12) Patent Application Publication
(10) Pub. No.: US 2011/0234496 A1
(43) Pub. Date: Sep. 29, 2011

(54) MOUSE AND STAY THEREOF

(76) Inventor: Jong Mun Wang, Gwangyang-si (KR)

(21) Appl. No.: 12/671,913

(22) PCT Filed: Jul. 23, 2008
(86) PCT No.: PCT/KR08/04312

§ 371 Date: Feb. 2, 2010

(30) Foreign Application Priority Data
Aug. 2, 2007 (KR) 10-2007-0077650

(51) Int. Cl. G06F 3/033

(52) U.S. Cl. 345/163

(57) ABSTRACT

A mouse and a stay thereof are disclosed. The mouse includes an up/down guide part formed on a body, and a finger supporting part supported by the up/down guide part so as to move up and down and including supporting arms extended opposite to each other in a width direction. The mouse stay includes a base plate to movably keep the mouse on, a connecting part hingedly connected to a rear end portion of the base plate so that the connecting part can be pivoted to be folded or spread toward/from an upper surface of the base plate, and an extending part hingedly connected to an upper end portion of the connecting part so that the extending part can be pivoted to be folded or spread toward/from a front surface of the connecting part. A mouse cable is connected to a front end portion of the extending part.

### TECHNICAL FIELD

The present invention relates to a mouse and a stay thereof, and more particularly, to a mouse capable of enabling a user to conveniently grasp a mouse by adjusting a height of a finger supporting part for supporting an index finger and a middle finger on and capable of preventing interference with a mouse cable by extending the mouse cable upward from the finger supporting part and passing the mouse cable by a connecting portion between the index finger and the middle finger, and to a mouse stay applied to the above mouse.

### BACKGROUND ART

With rapid increase of use of personal computers, recently there have been many changes to computer operating softwares. At present, the most widely-used computer operating system is Windows. Most programs run on Windows are programmed such that a user can input commands using shortcuts. In addition, because most commands are respectively represented by icons, a user can accurately input commands and can easily select desired files by using a mouse, thereby improving convenience in use. Therefore, a mouse is used as an essential input device because of its contribution to improvement of working efficiency.

There are several types of mice, including a ball mouse using a rubber ball, an optical sensor type mouse using light, and an optomechanical mouse formed by combining a ball mouse and an optical sensor type mouse.

Such a mouse is one of input devices used to move a cursor or other objects in a screen, and is formed in a small box shape including a body which a user can easily grasp. A mouse is also provided with at least one (up to three) button, at a position which a user's finger reaches. If a user grasps a mouse and moves the mouse on a flat desk, an arrow-shaped or cross-shaped mouse pointer is moved on a screen according to the movement of the mouse. Also, a user can input a desired command by pushing a button by her/his index finger or middle finger.

### DISCLOSURE OF INVENTION

### Technical Problem

As described above, a user primarily uses her/his index finger or middle finger when intending to push a button of a mouse. However, because a conventional mouse is formed such that a user moves an index finger or a middle finger while holding a mouse body by a palm of a hand, a user's index finger or middle finger may be fatigued. Also, because mice on the market have almost uniform sizes, there are some cases in which it is inconvenient to use a mouse according to a user's hand size. For example, if a user's hand size is comparatively big and thus a finger length is comparatively long, the user should bend her/his finger to grasp a mouse body by the hand due to a uniform body size. Thus, the user's hand is fatigued quickly.

Also, because a conventional mouse has a structure such that a mouse cable is drawn out from a front end portion of a mouse body, when a user moves a mouse, a mouse body may interfere with a mouse cable, which causes inconvenience in moving a mouse.

Therefore, the present invention has been made in view of the above problems, and it is an object of the present invention to provide a mouse capable of enabling a user to conveniently grasp a mouse by adjusting a height of a finger supporting part for supporting an index finger and a middle finger and capable of preventing interference with a mouse cable by extending the mouse cable upward from the finger supporting part and passing the mouse cable by a connecting portion between the index finger and the middle finger.

It is another object of the present invention to provide a mouse stay enabling a user to conveniently use the above mouse provided with the finger supporting part and the mouse cable drawn out from the finger supporting part.

### Technical Solution

The above objects can be accomplished by the provision of a mouse for moving a pointer of a computer or clicking a command, the mouse comprising: an up/down guide part formed on an upper surface of a body of the mouse; and a finger supporting part supported by the up/down guide part so as to move up and down, the finger supporting part including supporting arms extended opposite to each other in a width direction.

The mouse may further comprise a cable drawn out from an area between the supporting arms of the finger supporting part.

In another aspect of the present invention, a mouse stay applied to the above mouse comprises: a base plate having an upper surface to movably keep the mouse on; a connecting part having a lower end portion hingedly connected to a rear end portion of the base plate so that the connecting part can be pivoted to be folded or spread toward/from an upper surface of the base plate; and an extending part having a rear end portion hingedly connected to an upper end portion of the connecting part so that the extending part can be pivoted to be folded or spread toward/from a front surface of the connecting part. A cable extended from the mouse is connected to a front end portion of the extending part.

Also, the extending part may include a tray for keeping things on.

Also, the connecting part may be provided with a USB connector and a headphone jack connected to a computer.

### Advantageous Effects

According to the above constitution, the mouse of the present invention is capable of enabling a user to conveniently grasp the mouse by adjusting a height of the finger supporting part for supporting an index finger and a middle finger on and capable of preventing interference with the mouse cable by extending the mouse cable upward from the finger supporting part and passing the mouse cable by a connecting portion between the index finger and the middle finger.

Further, the mouse stay according to the present invention enables a user to conveniently use the mouse provided with the finger supporting part and the mouse cable drawn out from the finger supporting part.

### BRIEF DESCRIPTION OF THE DRAWINGS

FIG. 1 is a perspective view illustrating a mouse according to an exemplary embodiment of the present invention.

FIG. 2 is a perspective view illustrating a state of using the mouse according to an exemplary embodiment of the present invention.

FIG. 3 is a side view illustrating a state of using the mouse according to an exemplary embodiment of the present invention.

FIG. 4 is a perspective view illustrating a mouse stay applied to the mouse according to an exemplary embodiment of the present invention.

FIG. 5 is a side view illustrating operation of the mouse stay applied to the mouse according to an exemplary embodiment of the present invention.

### BRIEF DESCRIPTION OF REFERENCE NUMERALS

10 mouse
11 body
12 up/down guide part
13 finger supporting part
14a, 14b supporting arm
15 cable
20 mouse stay
21 base plate
22 connecting plate
22a, 22b USB connector and headphone jack
23 extending part
23a arm
23b tray

### BEST MODE FOR CARRYING OUT THE INVENTION

Hereinafter, preferred embodiments of a mouse and a stay thereof according to the present invention will be described in detail with reference to the annexed drawings.

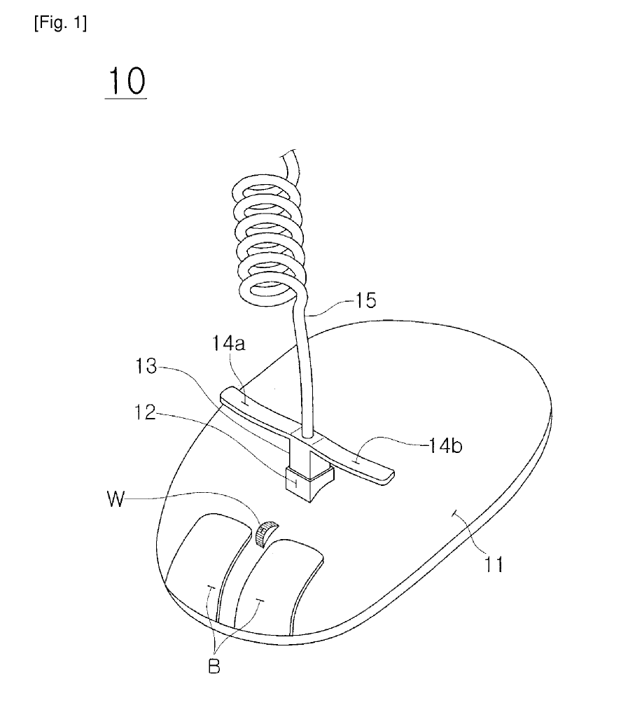

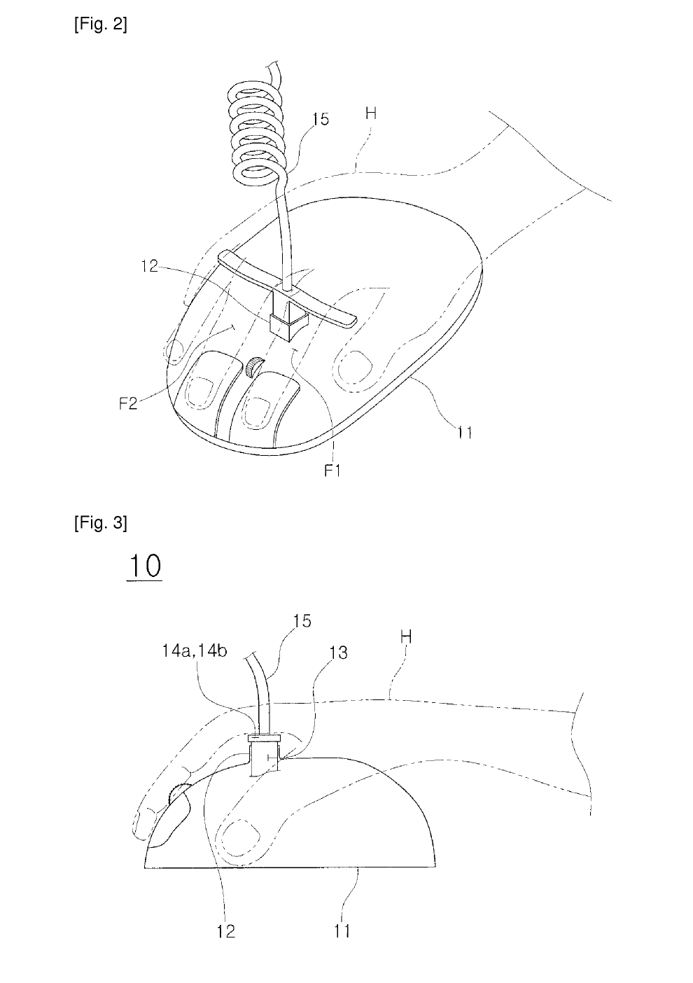

FIG. 1 is a perspective view illustrating a mouse according to an exemplary embodiment of the present invention, FIG. 2 is a perspective view illustrating a state of using the mouse according to an exemplary embodiment of the present invention, and FIG. 3 is a side view illustrating a state of using the mouse according to an exemplary embodiment of the present invention.

A mouse according to an exemplary embodiment of the present invention comprises a body 11 provided with a ball or an optical sensor at a lower portion thereof so as to move a pointer of a computer. The body 11 is formed in a dome shape having a round upper portion so that a user can easily grasp the body 11 by a hand (H). A user moves the mouse body 11 while grasping the same, and inputs a command by pushing two buttons (B). The mouse further comprises a mouse wheel (W) between the two buttons (B) so that a user can conveniently move a pointer or turn pages without moving the mouse. In the present invention, a finger supporting part 13 for supporting an index finger (F1) and a middle finger (F2) is supportedly mounted to an up/down guide part 12 above the mouse body 11. Referring to the drawings, the up/down guide part 12 for supporting the finger supporting part 13 to guide up/down movement of the finger supporting part 13 is formed on the upper surface of the body 11 of the mouse. The up/down guide part 12 includes edge portions protrudingly extended upward from the upper surface of the mouse body 11 by a predetermined height, through which a hole is formed in an up/down direction. The finger supporting part 13 serves to support the index finger (F1) and the middle finger (F2) of the hand (H) holding the mouse body 11. Referring to the drawings, the finger supporting part 13 includes supporting arms 14a and 14b extended opposite to each other in a wing shape in a width direction. The index finger (F1) and the middle finger (F2) are put on the supporting arms 14a and 14b. The supporting arms 14a and 14b respectively have a width sufficient to comfortably support the index finger (F1) and the middle finger (F2), and respectively have a concave middle portion in which the index finger (F1) and the middle finger (F2) are securely received. The finger supporting part 13 is supported by the up/down guide part 12 so as to move up and down and to be adjusted in height. That is, a lower end portion of the finger supporting part 13 is inserted into the up/down guide part 12, so as to move up and down. Accordingly, a user can increase the height of the finger supporting part 13 by drawing out the finger supporting part 13 upward from the up/down guide part 12, and also can decrease the height by putting the finger supporting part 13 into the up/down guide part 12.

The mouse 10 according to the present invention further comprises a mouse cable 15 connected to a computer. The mouse cable 15 is drawn out from an area between the supporting arms 14a and 14b of the finger supporting part 13, so as to avoid interference of the mouse body with the mouse cable 15. Therefore, when a user grasps the mouse body 11 by the hand (H), the mouse cable 15 passes by a connecting portion between the index finger (F1) and the middle finger (F2) put on the finger supporting part 13, and is extended upward. As a result, interference of the mouse body with the mouse cable 15 is prevented. Specifically, as described above, because the mouse cable 15 drawn out from the area between the supporting arms 14a and 14b of the finger supporting part 13 is extended upward and hung on a below-described mouse stay 20, user's operation to move the mouse 10 is not disturbed.

Hereinafter, the mouse stay 20 for conveniently using the mouse 10 according to an exemplary embodiment of the present invention will be explained in detail.

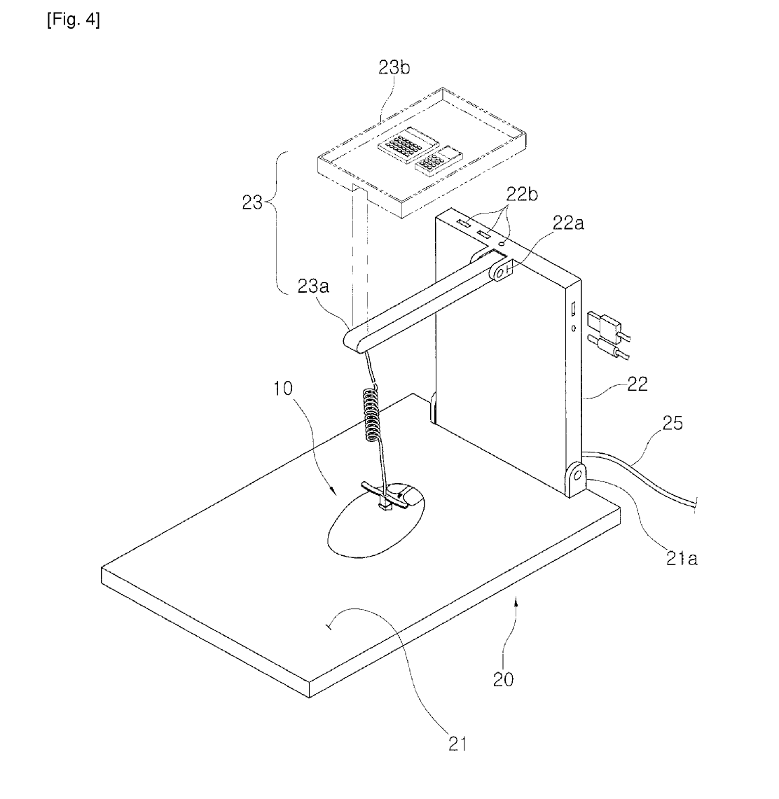

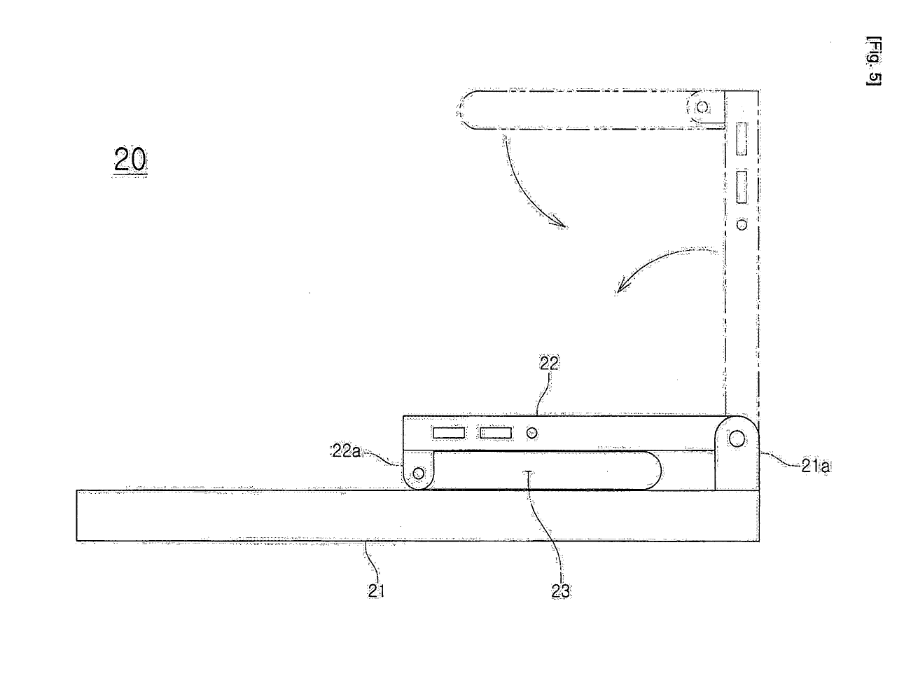

FIG. 4 is a perspective view illustrating the mouse stay applied to the mouse according to an exemplary embodiment of the present invention, and FIG. 5 is a side view illustrating operation of the mouse stay applied to the mouse according to an exemplary embodiment of the present invention.

Referring to the drawings, the mouse stay 20 according to an exemplary embodiment of the present invention includes a base plate 21, a connecting part 22 and an extending part 23.

The base plate 21 is configured as a plate member having an upper surface, on which the mouse 10 is put to be moved. The base plate 21 is provided with hinges 21a at a rear end portion thereof, to which the connecting part 22 is hingedly connected.

The connecting part 22 is configured as a plate member which is foldably connected to the base plate 21 and is extended upward. Referring to the drawings, a lower end portion of the connecting part 22 is hingedly connected to the hinges 21a provided at the rear end portion of the base plate 21 so that the connecting part 22 can be pivoted in a direction of being folded or spread toward/from the upper surface of the base plate 21. The connecting part 22 is provided with a USB connector and a headphone jack 22b which are connected to a computer through a cord 25. The connecting part 22 is also provided with hinges 22a at an upper end portion thereof, to which the extending part 23 is connected.

A rear end portion of the extending part 23 is hingedly connected to the hinges 22a provided at the upper end portion of the connecting part 22 so that the extending part 23 can be pivoted in a direction of being folded or spread toward/from a front surface of the connecting part 22. The mouse cable 15 drawn out from the mouse is connected to a front end portion of the extending part 23. The extending part 23 may include a tray 23b for keeping things on. It is illustrated in the drawings that the tray 23b is removably mounted to an arm 23a which is hingedly connected to the connecting part 22.

When the mouse stay 20 as constituted above is in a spread state in a U shape, viewed from the side, the mouse 10 can be put on the base plate 21 to be used. On the other hand, as shown in FIG. 5, the mouse stay can be kept in a non-used state by folding the extending part 23 over the front surface of the connecting part 22, and then by folding the connecting part 22 over the upper surface of the base plate 21.

### INDUSTRIAL APPLICABILITY

The mouse according to the present invention is capable of enabling a user to conveniently grasp the mouse by adjusting a height of the finger supporting part for supporting an index finger and a middle finger and capable of preventing interference with the mouse cable by extending the mouse cable upward from the finger supporting part and passing the mouse cable by a connecting portion between the index finger and the middle finger, and the mouse stay according to the present invention is effective in using the mouse provided with the finger supporting part and the mouse cable drawn out from the finger supporting part.

1. A mouse for moving a pointer of a computer or clicking a command, the mouse comprising:
an up/down guide part formed on an upper surface of a body of the mouse; and
a finger supporting part supported by the up/down guide part so as to move up and down, the finger supporting part including supporting arms extended opposite to each other in a width direction.

2. The mouse according to claim 1, further comprising: a cable drawn out from an area between the supporting arms of the finger supporting part.

3. A mouse stay applied to the mouse according to claim 2, the mouse stay comprising:
a base plate having an upper surface to movably keep the mouse on;
a connecting part having a lower end portion hingedly connected to a rear end portion of the base plate so that the connecting part can be pivoted to be folded or spread toward/from an upper surface of the base plate; and
an extending part having a rear end portion hingedly connected to an upper end portion of the connecting part so that the extending part can be pivoted to be folded or spread toward/from a front surface of the connecting part,
wherein a cable extended from the mouse is connected to a front end portion of the extending part.

4. The mouse stay according to claim 3, wherein the extending part includes a tray for keeping things on.

5. The mouse stay according to claim 3, wherein the connecting part is provided with a USB connector and a headphone jack connected to a computer.

6. The mouse stay according to claim 4, wherein the connecting part is provided with a USB connector and a headphone jack connected to a computer.
